(19) United States
(12) Patent Application Publication
(10) Pub. No.: US 2013/0093690 A1
(43) Pub. Date: Apr. 18, 2013

(54) Multi-Action Game Controller with Touch Screen Input Device

(71) Applicants: Matthew Nicholas Papakipos, Palo Alto, CA (US); Matthew Cahill, San Francisco, CA (US)

(72) Inventors: Matthew Nicholas Papakipos, Palo Alto, CA (US); Matthew Cahill, San Francisco, CA (US)

(21) Appl. No.: 13/275,152

(22) Filed: Oct. 17, 2011

(51) Int. Cl. G06F 3/041

(52) U.S. Cl. 345/173

(57) ABSTRACT

In one embodiment, a player controls a computer game by using one or more touch events associated with a touch screen interface and a touchpad interface.

### TECHNICAL FIELD

The present disclosure relates generally to touch-based user interfaces, and more particularly to, a handheld device having a touch-screen interface and a touchpad mounted on a lateral edge of the handheld device and applications for such devices.

### BACKGROUND

A touchpad is an input device including a surface that detects touch-based inputs of users. A touch screen is an electronic visual display that detects the presence and location of user touch inputs. A mobile device—such as a mobile phone, a tablet computer, a netbook computer, and a laptop computer—often incorporate a touch screen or a touchpad to facilitate user interactions with application programs running on the mobile device.

### SUMMARY

Particular embodiments relate to controlling a computer game by using a combination of a software-based controller element rendered on a display and a hardware-based controller implemented as a side-mounted touch surface. These and other features, aspects, and advantages of the disclosure are described in more detail below in the detailed description and in conjunction with the following figures.

### BRIEF DESCRIPTION OF THE DRAWINGS

FIG. 1 illustrates an example touch screen of a mobile phone that hosts a browser client displaying a web page.

FIG. 2 illustrates an example processing stack of a mobile device with touch-based input device(s).

FIG. 3 illustrates a front view and a side view of an example mobile device with a front-mounted touch screen and a side-mounted touchpad.

FIG. 3A illustrate another example of the mobile device in FIG. 3.

FIGS. 3B-3G illustrate example touch events associated with the example mobile device of FIG. 3.

FIGS. 4A-4B illustrate example touch events associated with the example mobile device of FIG. 3.

FIG. 4C-4D illustrate an example web browser application presented on a mobile device.

FIG. 4E-4F illustrate an example map application presented on a mobile device.

FIGS. 5A-5C illustrate an example computer game presented on a mobile device.

FIG. 6 illustrates an example mobile device platform.

### DETAILED DESCRIPTION

The invention is now described in detail with reference to a few embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order not to unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

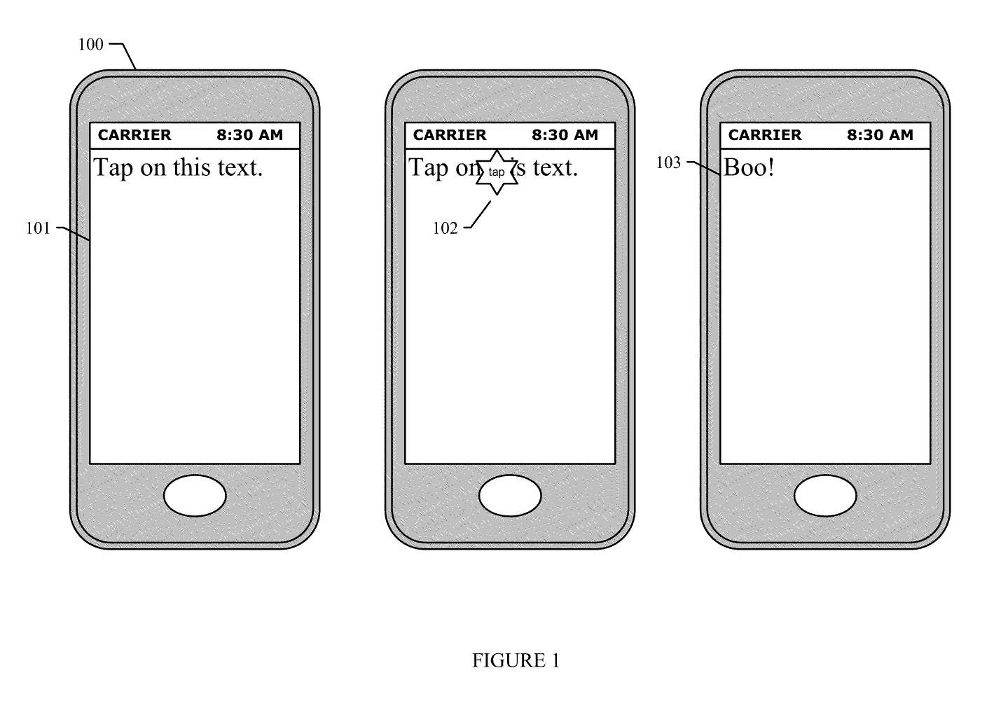

A touchpad is an input device including a surface that detects touch-based inputs of users. Similarly, a touch screen is an electronic visual display that detects the presence and location of user touch inputs. So-called dual touch or multi-touch displays or touchpads refer to devices that can identify the presence, location and movement of more than one touch input, such as two or three finger touches. A touch screen or touchpad includes a sensor (such as a capacitive sensor) and associated digital and analog control circuits to detect touch or near touch inputs from a user. When one or more such user inputs occur, a system incorporating a touch screen or touchpad may determine the distinct area(s) of contact and identify the nature of the touch or near touch input(s) via geometric features and geometric arrangements (e.g., location, movement), and determine if they correspond to various touch events or gestures (e.g., tap, drag, swipe, pinch). These touch events or gestures may then be processed by handler functions that register or subscribe as listeners to such events. FIG. 1 illustrates an example touch screen of a mobile phone that hosts a browser client displaying a web page. In the example of FIG. 1, touch screen 101 of mobile phone 100 displays an HTML/JavaScript code snippet displaying a text string “Tap on this text”, as listed below.

<html>
<!-- pseudo-code to include a touch event listener from a touch events
library
library TouchEventsLibrary
function onTapEvent
-->
<body>
<h1 onTapEvent=“this.innerHTML=‘Boo!’”>Click on this text</h1>
</body>
</html>

As a user taps on the text string “Tap on this text.” (102), a touch event listener “onTouchEvent” can trigger an action of changing the text string from “Tap on this text.” to “Boo!” (103).

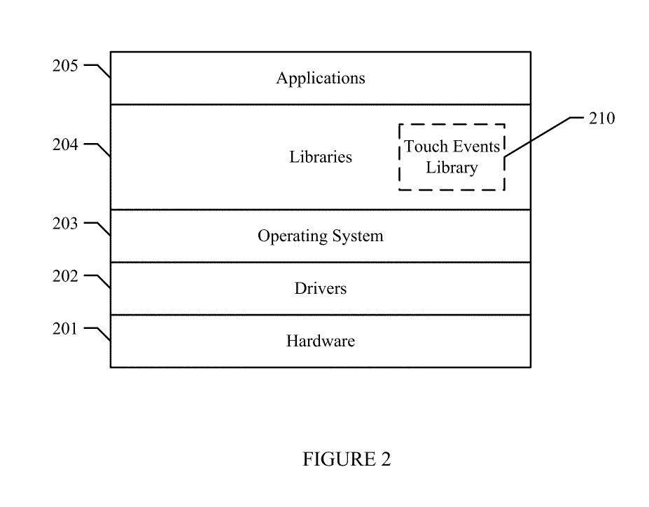

Recognition of touch events by a system with one or more touch-based input devices—i.e., identifying one or more touch inputs by a user and determining corresponding touch event(s)—may be implemented by a combination of hardware, software, and/or firmware (or device drivers). FIG. 2 illustrates an example processing stack of a mobile device (e.g., a smart phone) with touch-based input device(s). Hardware layer 201 can include one or more processors and various hardware input/output devices such as a camera, communication interface, and touch-based input device (e.g., touch screen, touchpad, etc.). Drivers layer 202 includes one or more drivers that communicate and control hardware layer 200, for example, a driver receiving and processing touch input signals generated by a touch-screen display. Operating system 203 runs computing programs and manages hardware layer 201 via one or more drivers in driver layer 202. Libraries 204 includes one or more libraries used by one or more application programs in applications 205 (e.g., web browser, address book, etc.). For example, touch events library 210 can contain computer program code that interprets touch inputs to touch events or gestures. A web browser application program can access touch event library 210 (e.g., via function calls) and process a web page with touch event handlers embedded within the page, as illustrated in FIG. 1 and in the HTML/JavaScript code snippet above. The browser client or other applications may also operate in connection with touch event handlers contained within the context of the application.

In many computer games, there is a virtual world or some other imagined playing space where a player/user of the game controls one or more player characters, which can be considered in-game representations of the controlling player. A game display can display a representation of the character, a partial representation of a character or no representation of a character. A game program can accept inputs from the player, determine character actions, decide outcomes of events, adjust the state of one or more data objects representing characters, non-player characters and other elements of the game and render the objects for display. In some games, there are multiple players, wherein each player controls one or more characters.

In many computer games, there are various in-game actions that a character can make with a game. For example, a character in a car racing game can select a particular car the character drives, make various maneuvering actions with the car (e.g., left turn, right turn, accelerate, break, etc.), check status of the race (what's the score, how many miles left in the race, course condition, etc.). For example, a character in a first person shooting game can select or change a weapon, aim the weapon at a particular target, fire the weapon, reload ammunition, survey the surroundings, make various actions within the battlefield, etc. A character in an online poker game can play at specific tables, place bets of virtual currency for certain amounts, play or fold certain hands, play in an online poker tournament, etc.

One or more players can access a computer game hosted by one or more computing systems (e.g., a game console, a laptop computer, a mobile phone, a remote server) by using a game display and one or more game input devices. For example, a game display can be a graphical user interface of a game program. For example, a game display can be a graphical user interface of a special-purpose client application or a web browser for an online game. A game input device can be a computer keyboard, a computer mouse, a touchpad, a touch screen, a joystick, a game controller, or any combination of the foregoing. A game controller can have many hardware buttons to accommodate many actions and options available for a computer game. For example, an Xbox 360 Controller for the Xbox 360 game console by Microsoft has a variety of buttons and mini-joysticks.

On the other hand, interacting with a computer game on a mobile device such as a touch-screen mobile phone can become challenging because smaller size of display and limited number of hardware buttons. For example, in a first-person shooter, the application may provide a first virtual joystick or interface element for controlling a weapon of the character and a second virtual joystick or interface element for adjusting a field of view. In one implementation, these virtual interface elements may be implemented as circular regions rendered on the display. A user provides inputs by moving the position of thumbs or fingers around the center of each circular region. These virtual interface elements take up valuable display area which could otherwise by used to render a larger scene.

Particular embodiments herein relate to a handheld computing device (such as a mobile phone, tablet, or other portable device) having a touch-screen interface and a touchpad mounted on a lateral edge of the handheld device and applications for such devices. Particular embodiments can improve computer game playing experience associated with mobile devices as the touchpad(s) in conjunction with the touch screen enable more game control options.

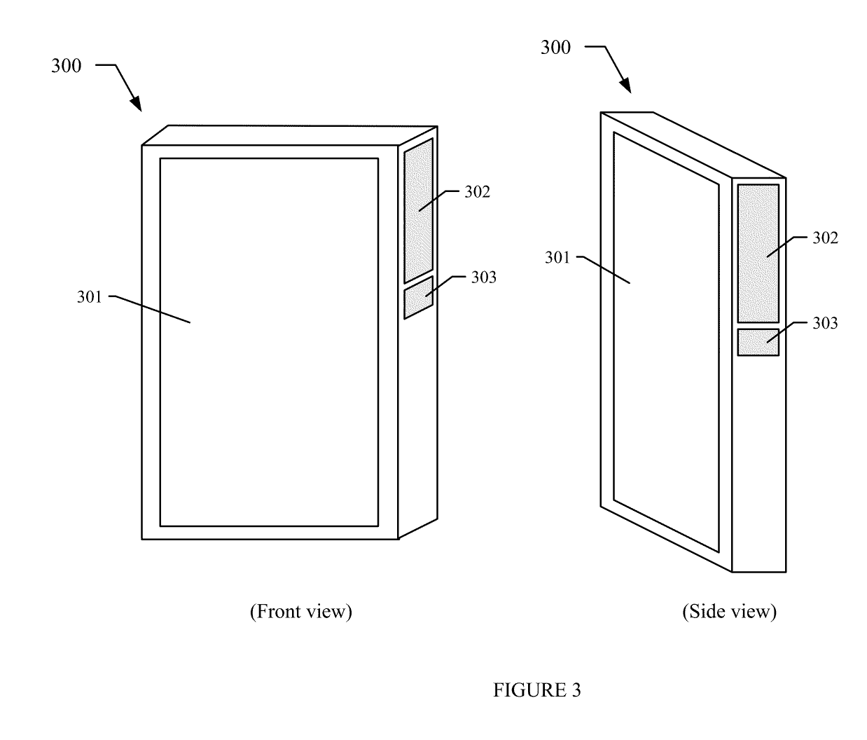

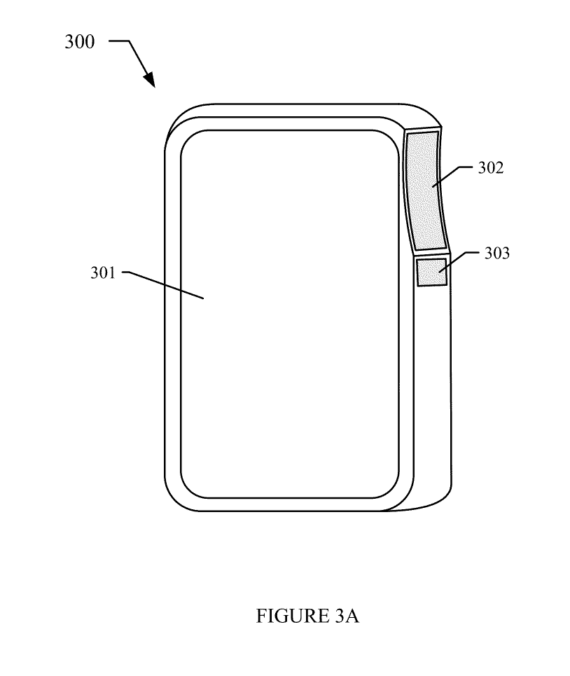

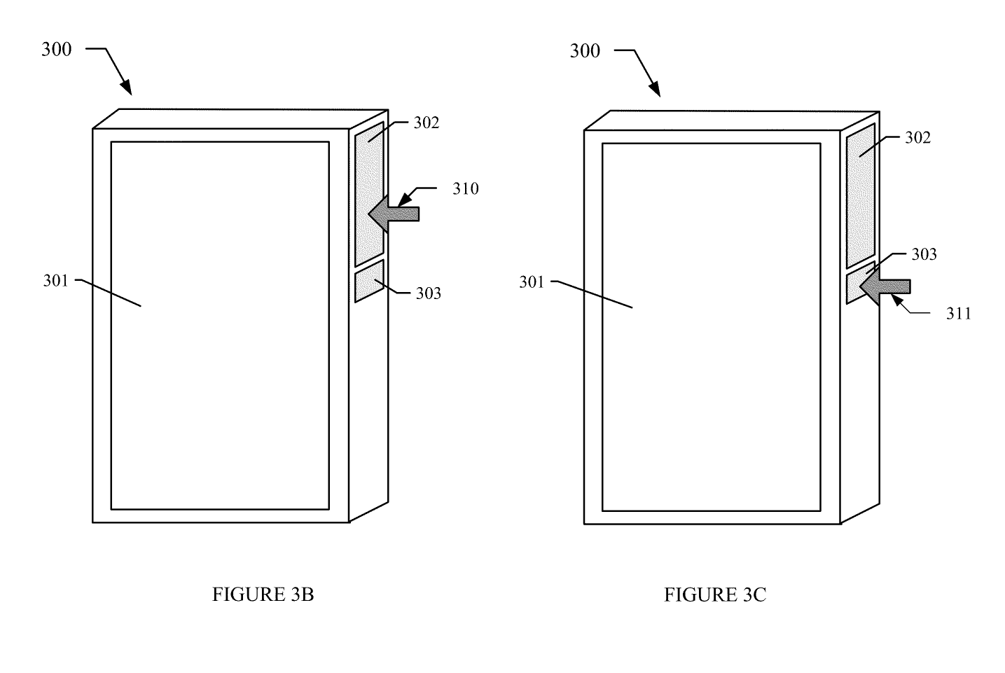

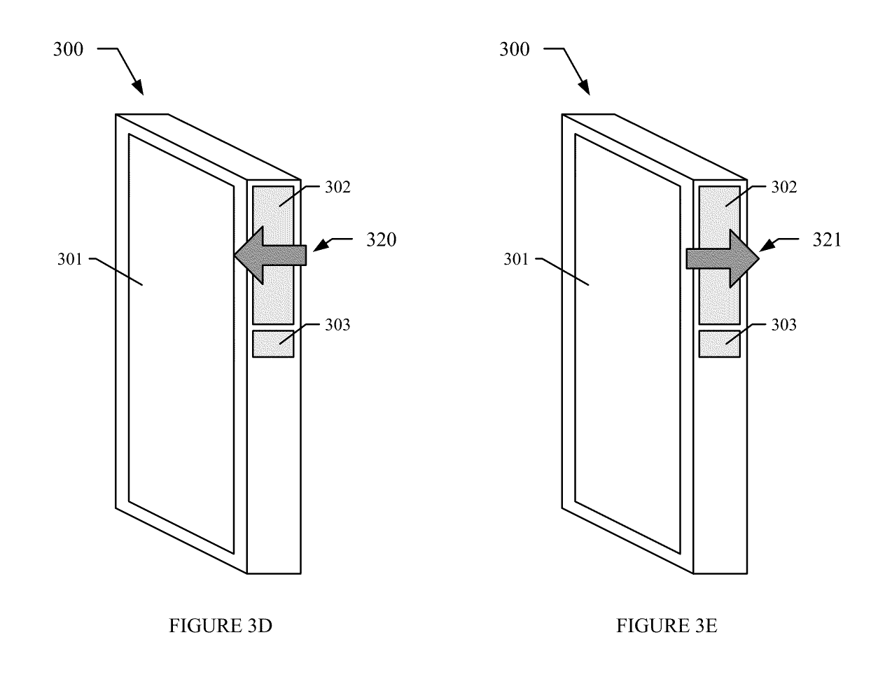

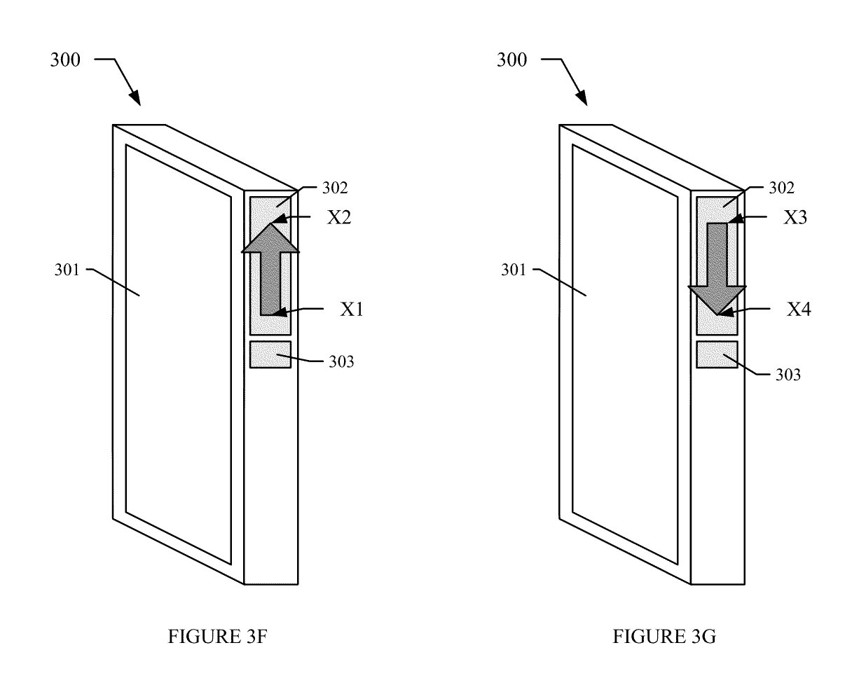

FIG. 3 illustrates a front view and a side view of an example mobile device with a front-mounted touch screen and a side-mounted touchpad disposed on a lateral edge of the housing of the mobile device. In particular embodiments, mobile device 300 may comprise a front-mounted multi-touch display screen 301, a side-mounted multi-touch touchpad 302, and a side-mounted single-touch touchpad 303. In particular embodiments, mobile device 300 may include hardware and/or software adapted for one or more functions, such as, telephony, email, chat, web browsing, network data communications (e.g., Wi-Fi, Generic Packet Radio Service, and the like), digital media player, and/or gaming. In one embodiment, the side-mounted touchpad 303 may be replaced by a clickable button or keypad device. In some embodiments, side-mounted touchpad 302 may comprise a slightly concave surface, as illustrated in FIG. 3A. The touch screen 301 and side-mounted touchpad 303 may be single-touch, dual-touch or multi-touch devices. In addition, implementations of the invention can operate without a touch screen device, relying instead on a regular display device and a pointer device, such as a trackball or trackpad.

Mobile device 300 may recognize touch inputs, and determine one or more corresponding touch events or gestures. One or more applications hosted on mobile device 300 may be configured to register a handler function that responds to the one or more touch events. In particular embodiments, mobile device 300 may recognize one or more user touch inputs performed on touch screen 301, touchpad 302, and/or touchpad 303, and determine one or more corresponding touch events. In particular embodiments, mobile device 300 may identify a tap event associated with touchpad 302, as illustrated in FIG. 3B. In the example of FIG. 3B, a user taps or strikes lightly on touchpad 302 (as indicated by arrow 310). Mobile device 300 can recognize the user's touch input on touchpad 302 and identify the touch input corresponding to a tap event. In particular embodiments, mobile device 300 may determine a tap event associated with touchpad 303, as illustrated in FIG. 3C. In the example of FIG. 3C, a user taps or strikes lightly on touchpad 303 (as indicated by arrow 311). Mobile device 300 can recognize the user's touch input and identify the touch input corresponding to a tap event associated with touchpad 303.

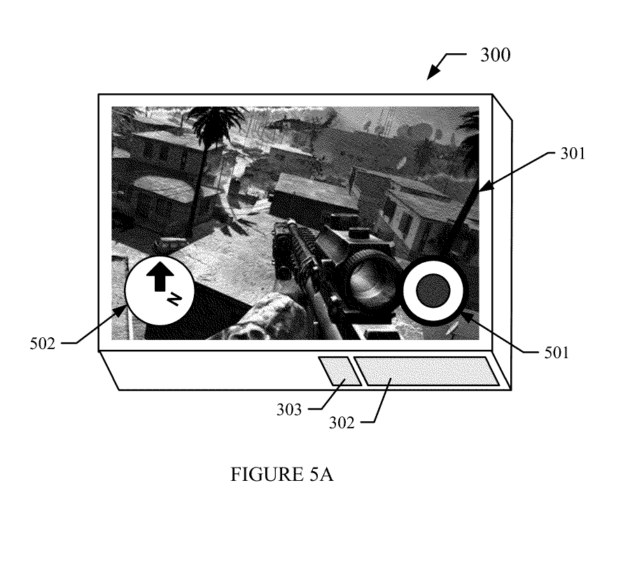

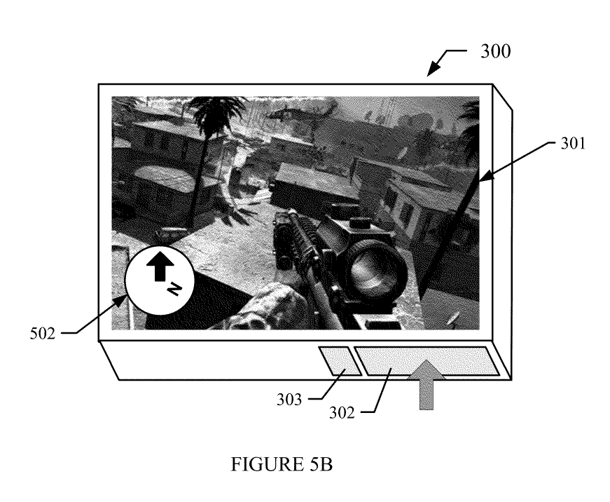

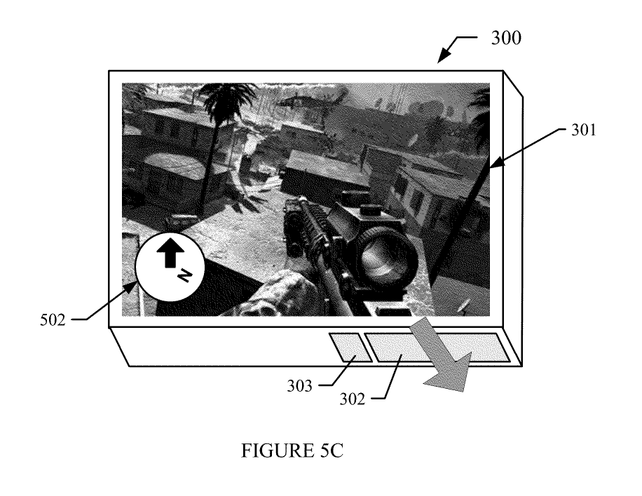

In particular embodiments, mobile device 300 may identify a forward lateral flick gesture associated with touchpad 302, as illustrated in FIG. 5B. In the example of FIG. 3D, a user touches touchpad 302 in a quick motion in forward lateral direction (indicated by the arrow 320). Mobile device 300 can recognize the user's touch input and identify the touch input corresponding to a forward lateral flick event. In particular embodiments, mobile device 300 may determine a backward lateral flick event associated with touchpad 302, as illustrated in FIG. 3E. In the example of FIG. 3E, a user touches touchpad 302 in a quick motion in backward lateral direction (indicated by the arrow 321). Mobile device 300 can recognize the user's touch input and identify the touch input corresponding to a backward lateral flick event.

In particular embodiments, mobile device 300 may identify an upward scrolling event associated with touchpad 302 based on a corresponding scrolling touch gesture of a user, as illustrated in FIG. 3F. In the example of FIG. 3F, a user touches touchpad 302 in a upward motion (e.g., the user's finger touches touchpad 302 at a start location X1, moves the finger upwards while the figure is still in contact with touchpad 302, and the finger lifts away from touchpad 302 at an end location X2 wherein the end location X2 is closer to the top of mobile device 300 then the start location X1, as indicating by the arrow in FIG. 3F). Mobile device 300 may access data generated by touchpad 302 and identify an upward scrolling event or gesture associated with touchpad 302. In particular embodiments, mobile device 300 may determine a downward scrolling event associated with touchpad 302, as illustrated in FIG. 3G. In the example of FIG. 3G, a user touches touchpad 302 in a downward motion (e.g., the user's finger touches touchpad 302 at a start location X3, moves the finger downwards while the finger is still in contact with touchpad 302, and the finger lifts away from touchpad 302 at an end location X4 wherein the start location X3 is closer to the top of mobile device 300 then the end location X4, as indicating by the arrow in FIG. 3G), and mobile device 300 may determine a downward scrolling event associated with touchpad 302. The upwards or downwards gestures made by a user may be controlled scrolling gestures where the movement is slow relative to a swiping gesture where the associated downward or upward movement is relatively abrupt or fast. A gesture recognition library of mobile device 400 may interpret the inputs from touchpad 402 to recognize either gesture type. A handler function may respond differently between a controlled scroll and a swipe gesture. For example, a swipe gesture may cause an application to rapidly scroll a document based on the speed of the swipe. On the other hand, an application may respond to a controlled scrolling event by scrolling the document or other content in a manner proportional to the user's movements relative to touchpad 402.

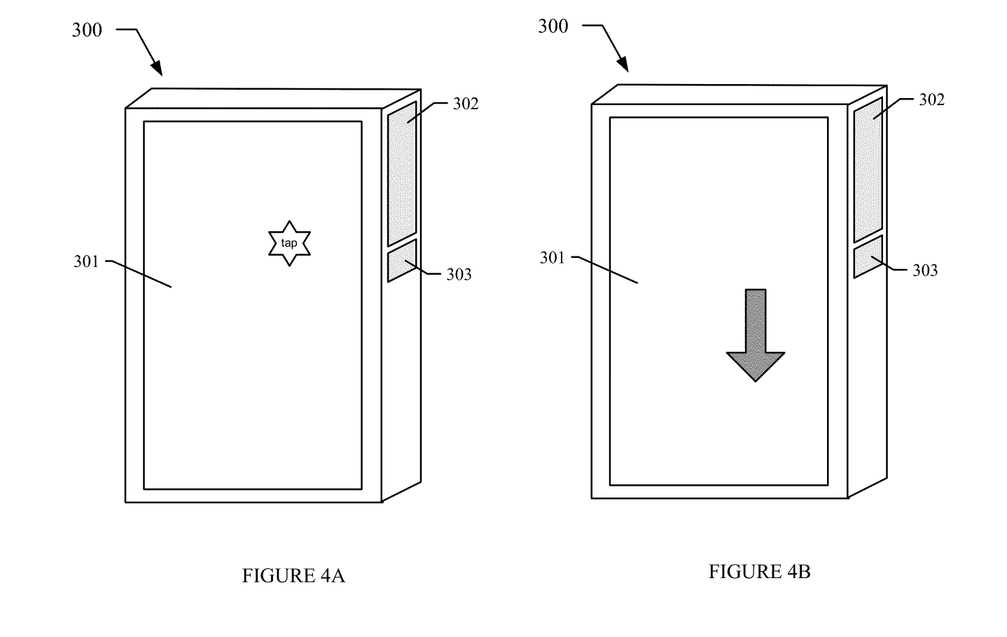

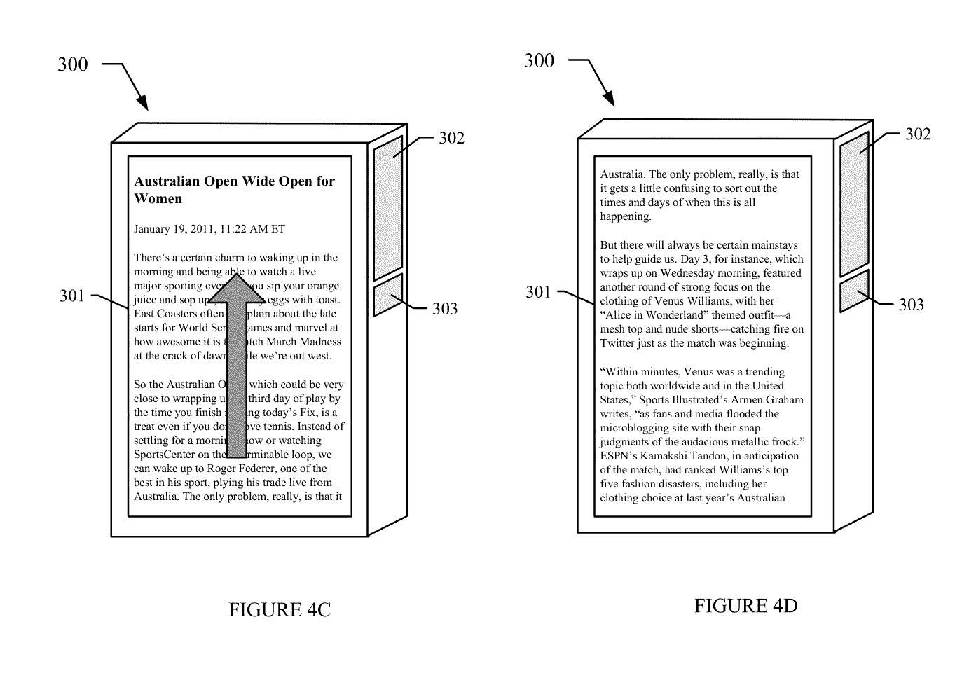

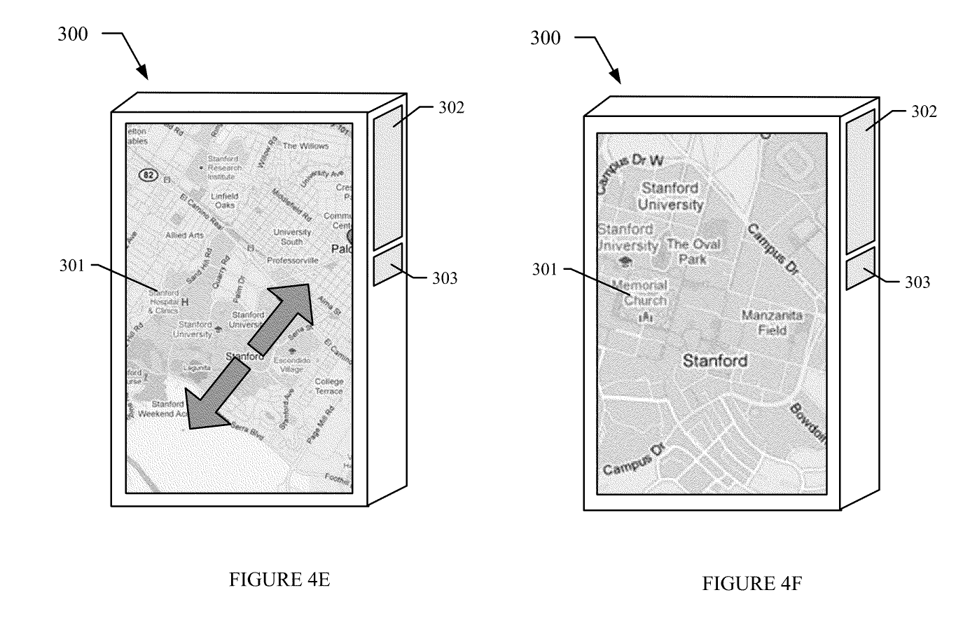

Similar to touch events associated with touch pads 302 and 303, mobile device 300 may recognize touch events associated with touch screen 301. In particular embodiments, mobile device 300 may identify a tap event associated with touch screen 301, as illustrated in FIG. 4A. In the example of FIG. 4A, a user taps or strikes lightly on touch screen 301. Mobile device 300 can recognize the user's touch input and identify the touch input corresponding to a tap event associated with touch screen 301.

In particular embodiments, mobile device 300 may identify a swipe event associated with touch screen 301, as illustrated in FIG. 4B. In the example of FIG. 4B, a user touches touch screen 302 in a swiping motion, as indicated by the arrow in FIG. 4B. A swipe event may be of any direction, for example, upward, downward, to the left, to the right, etc. For example, a user of mobile device 300 can scroll down a web page displayed by a web browser in touch screen 301 by a swiping across touch screen 301, as illustrated by the arrow in FIG. 4C. Mobile device 300 can identify a swipe touch event or gesture in the upward direction, causing the web browser to display the next available portion of the web page, as illustrated in FIG. 4D.

In particular embodiments, mobile device 300 may determine a touch gesture comprising one or more sequences of timed touch points. For example, a user can touch or place two fingers on touch screen 301 and moves the fingers apart, as illustrated by the arrows in FIG. 4E, and mobile device 300 can identify the touch event as a pinch-out touch gesture. For example, a user of mobile device 300 can place two fingers on a map displayed in touch screen 301 by a map application, moves the fingers apart as illustrated in FIG. 4E. Mobile device 300 can identify a pinch-out touch gesture, causing the map application to zoom in to the location of the pinch-out touch gesture, as illustrated in FIG. 4F.

In contrast to using dedicated input devices for controlling a computer game (e.g., a game controller, a keyboard, a touch screen), particular embodiments may implement methods of controlling a computer game by a touch screen and a touchpad. In particular embodiments, a computer game may present a game graphical user interface within a touch screen of a computing device comprising the touch screen interface and a touch pad interface. By registering a handler function for touch events, the handler function can, responsive to one or more touch events associate with the touch screen or the touch pad, cause the computer game to determine one or more game action controls. In particular embodiments, the computer game may execute the one or more game action controls corresponding to the one or more touch events.

FIGS. 5A-5C illustrate an example computer game presented on a mobile device. In the example of FIG. 5A, a first-person shooter game is presented on touch screen 301 of mobile device 300. The first-person shooter game can define game control actions based on touch events or gestures associated with mobile device 300. For example, the first-person shooter game can have a set of dual-thumb virtual joysticks by implementing a first virtual joystick 501 rendered on touch screen 301 for controlling a weapon of the character and a second virtual joystick 502 rendered on touch screen 301 for adjusting a field of view for the character (e.g., by registering a handler function as a listener to touch events associated with touch screen 301). For example, a user can tap his thumb on first virtual joystick 501 to cause the first-person shooter game to execute an action of shooting a single shot, use his thumb to tap and hold (e.g., for 1 second) on first virtual joystick 501 to cause the first-person shooter game to execute an action of shooting a three-round burst, or swipe his thumb across first virtual joystick 501 to cause the first-person shooter game to execute an action of launching a grenade. For example, a user can swipe his thumb around the center of the circular region of second virtual joystick 502 to cause the first-person shooter game to change the view to the left or right of a current view for the character.

Instead of having first virtual joystick 501 taking up valuable display area of touch screen 301, the first-person shooter game can implement an interface for controlling a weapon of the character by registering a handler function as a listener to touch gestures associated with side-mounted touchpad 302. For example, in response to a tap gesture associated with touchpad 302 (as illustrated in FIG. 5B), the handler function can cause the first-person shooter game to execute an action of shooting a single shot. For example, a user may press and hold his thumb (e.g., for 1 second) on touchpad 302. In response to the press-and-hold gesture associated with touchpad 302, the handler function can cause the first-person shooter game to execute an action of shooting a three-round burst. For example, in response to a backward lateral flick gesture associated with touchpad 302 (as illustrated in FIG. 5C), the handler function can cause the first-person shooter game to execute an action of launching a grenade. Meanwhile, a user can swipe his thumb around the center of the circular region of second virtual joystick 502 rendered on touch screen 301 to cause the first-person shooter game to change the view to the left or right of a current view for the character. In one embodiment, the first-person shooter game can implement an interface for controlling a weapon of the character by registering one or more handler functions as listeners to touch gestures associated with side-mounted touchpad 302 and side-mounted touchpad 303. For example, a user may tap his thumb on touchpad 302 to cause the first-person shooter game to execute an action of shooting a single shot, press and hold his thumb on touchpad 302 to cause the first-person shooter game to execute an action of shooting a three-round burst, and tap his thumb on touchpad 303 to cause the first-person shooter game to execute an action of launching a grenade.

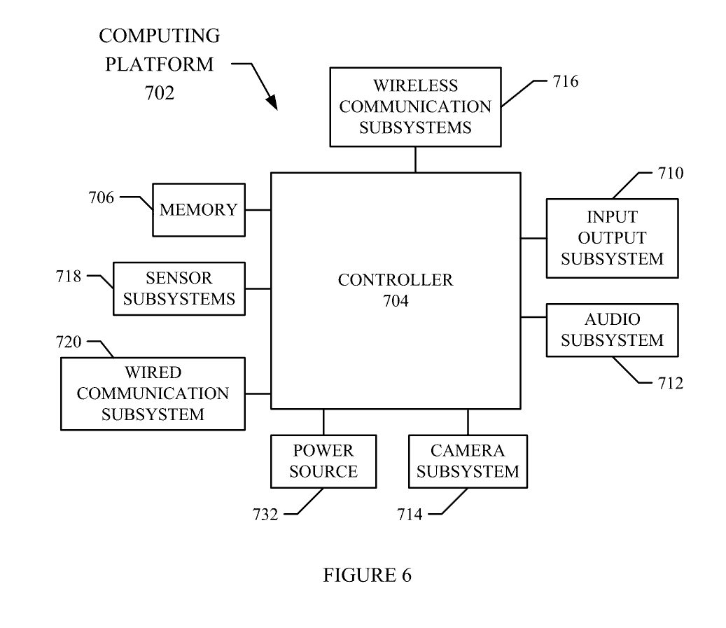

The application and functionality described above can be implemented as a series of instructions stored on a computer-readable storage medium that, when executed, cause a programmable processor to implement the operations described above. While the mobile device 300 may be implemented in a variety of different hardware and computing systems, FIG. 6 shows a schematic representation of the main components of an example computing platform of a client or mobile device, according to various particular embodiments. In particular embodiments, computing platform 702 may comprise controller 704, memory 706, and input output subsystem 710. In particular embodiments, controller 704 which may comprise one or more processors and/or one or more microcontrollers configured to execute instructions and to carry out operations associated with a computing platform. In various embodiments, controller 704 may be implemented as a single-chip, multiple chips and/or other electrical components including one or more integrated circuits and printed circuit boards. Controller 704 may optionally contain a cache memory unit for temporary local storage of instructions, data, or computer addresses. By way of example, using instructions retrieved from memory, controller 704 may control the reception and manipulation of input and output data between components of computing platform 702. By way of example, controller 704 may include one or more processors or one or more controllers dedicated for certain processing tasks of computing platform 702, for example, for 2D/3D graphics processing, image processing, or video processing.

Controller 704 together with a suitable operating system may operate to execute instructions in the form of computer code and produce and use data. By way of example and not by way of limitation, the operating system may be Windows-based, Mac-based, or Unix or Linux-based, Android-based, or Symbian-based, among other suitable operating systems. The operating system, other computer code and/or data may be physically stored within memory 706 that is operatively coupled to controller 704.

Memory 706 may encompass one or more storage media and generally provide a place to store computer code (e.g., software and/or firmware) and data that are used by computing platform 702. By way of example, memory 706 may include various tangible computer-readable storage media including Read-Only Memory (ROM) and/or Random-Access Memory (RAM). As is well known in the art, ROM acts to transfer data and instructions uni-directionally to controller 704, and RAM is used typically to transfer data and instructions in a bi-directional manner. Memory 706 may also include one or more fixed storage devices in the form of, by way of example, hard disk drives (HDDs), solid-state drives (SSDs), flash-memory cards (e.g., Secured Digital or SD cards, embedded MultiMediaCard or eMMD cards), among other suitable forms of memory coupled bi-directionally to controller 704. Information may also reside on one or more removable storage media loaded into or installed in computing platform 702 when needed. By way of example, any of a number of suitable memory cards (e.g., SD cards) may be loaded into computing platform 702 on a temporary or permanent basis.

Input output subsystem 710 may comprise one or more input and output devices operably connected to controller 704. For example, input-output subsystem may include keyboard, mouse, one or more buttons, thumb wheel, and/or display (e.g., liquid crystal display (LCD), light emitting diode (LED), Interferometric modulator display (IMOD), or any other suitable display technology). Generally, input devices are configured to transfer data, commands and responses from the outside world into computing platform 702. The display is generally configured to display a graphical user interface (GUI) that provides an easy to use visual interface between a user of the computing platform 702 and the operating system or application(s) running on the mobile device. Generally, the GUI presents programs, files and operational options with graphical images. During operation, the user may select and activate various graphical images displayed on the display in order to initiate functions and tasks associated therewith. Input output subsystem 710 may also include touch based devices such as touchpad and touch screen. A touchpad is an input device including a surface that detects touch-based inputs of users. Similarly, a touch screen is a display that detects the presence and location of user touch inputs. Input output system 710 may also include dual touch or multi-touch displays or touchpads that can identify the presence, location and movement of more than one touch inputs, such as two or three finger touches.

In particular embodiments, computing platform 702 may additionally comprise audio subsystem 712, camera subsystem 712, wireless communication subsystem 716, sensor subsystems 718, and/or wired communication subsystem 720, operably connected to controller 704 to facilitate various functions of computing platform 702. For example, Audio subsystem 712, including a speaker, a microphone, and a codec module configured to process audio signals, can be utilized to facilitate voice-enabled functions, such as voice recognition, voice replication, digital recording, and telephony functions. For example, camera subsystem 712, including an optical sensor (e.g., a charged coupled device (CCD), or a complementary metal-oxide semiconductor (CMOS) image sensor), can be utilized to facilitate camera functions, such as recording photographs and video clips. For example, wired communication subsystem 720 can include a Universal Serial Bus (USB) port for file transferring, or a Ethernet port for connection to a local area network (LAN). Additionally, computing platform 702 may be powered by power source 732.

Wireless communication subsystem 716 can be designed to operate over one or more wireless networks, for example, a wireless PAN (WPAN) (such as, for example, a BLUETOOTH WPAN, an infrared PAN), a WI-FI network (such as, for example, an 802.11a/b/g/n WI-FI network, an 802.11s mesh network), a WI-MAX network, a cellular telephone network (such as, for example, a Global System for Mobile Communications (GSM) network, an Enhanced Data Rates for GSM Evolution (EDGE) network, a Universal Mobile Telecommunications System (UMTS) network, and/or a Long Term Evolution (LTE) network). Additionally, wireless communication subsystem 716 may include hosting protocols such that computing platform 702 may be configured as a base station for other wireless devices.

Sensor subsystem 718 may include one or more sensor devices to provide additional input and facilitate multiple functionalities of computing platform 702. For example, sensor subsystems 718 may include GPS sensor for location positioning, altimeter for altitude positioning, motion sensor for determining orientation of a mobile device, light sensor for photographing function with camera subsystem 714, temperature sensor for measuring ambient temperature, and/or biometric sensor for security application (e.g., fingerprint reader).

In particular embodiments, various components of computing platform 702 may be operably connected together by one or more buses (including hardware and/or software). As an example and not by way of limitation, the one or more buses may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, a Universal Asynchronous Receiver/Transmitter (UART) interface, a Inter-Integrated Circuit (I²C) bus, a Serial Peripheral Interface (SPI) bus, a Secure Digital (SD) memory interface, a MultiMediaCard (MMC) memory interface, a Memory Stick (MS) memory interface, a Secure Digital Input Output (SDIO) interface, a Multi-channel Buffered Serial Port (McBSP) bus, a Universal Serial Bus (USB) bus, a General Purpose Memory Controller (GPMC) bus, a SDRAM Controller (SDRC) bus, a General Purpose Input/Output (GPIO) bus, a Separate Video (S-Video) bus, a Display Serial Interface (DSI) bus, an Advanced Microcontroller Bus Architecture (AMBA) bus, or another suitable bus or a combination of two or more of these.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, a MultiMediaCard (MMC) card, an embedded MMC (eMMC) card, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101.

This disclosure contemplates one or more computer-readable storage media implementing any suitable storage. In particular embodiments, a computer-readable storage medium implements one or more portions of controller 704 (such as, for example, one or more internal registers or caches), one or more portions of memory 705, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, JavaScript, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. An apparatus, comprising:
a device housing;
a memory;
a touchpad interface disposed on a lateral edge of the device housing;
a touch screen display disposed on a front face of the device housing;
one or more processors;
computer program code stored on a non-transitory medium comprising instructions operative to cause the one or more processors to:
provide a first application and render one or more objects on the touch screen display;
present a first virtual controller element on the touch screen display;
respond to touch inputs on the touch screen display corresponding to the first virtual controller element by implementing one or more functions associated with the first virtual controller element; and
respond to touch inputs on the touchpad interface by implementing one or more functions associated with a second controller element.

2. The apparatus of claim 1, wherein the first application is a computer game application.

3. The apparatus of claim 1, wherein the touchpad interface comprises a concave surface.

4. One or more computer-readable tangible storage media embodying software operable when executed by a computing device to:
provide a first application and render one or more objects on a touch screen display disposed on a front face of the computing device;
present a first virtual controller element on the touch screen display;
respond to touch inputs on the touch screen display corresponding to the first virtual controller element by implementing one or more functions associated with the first virtual controller element; and
respond to touch inputs on a touchpad interface disposed on a lateral edge of the computing device, by implementing one or more functions associated with a second controller element.

5. A method, by a computing device, comprising:
providing a first application and render one or more objects on a touch screen display disposed on a front face of the computing device;
presenting a first virtual controller element on the touch screen display;
responding to touch inputs on the touch screen display corresponding to the first virtual controller element by implementing one or more functions associated with the first virtual controller element; and
responding to touch inputs on a touchpad interface disposed on a lateral edge of the computing device, by implementing one or more functions associated with a second controller element.
